(19) United States
(12) Patent Application Publication
(10) Pub. No.: US 2024/0028800 A1
(43) Pub. Date: Jan. 25, 2024

(54) VISCOUS FLUID SIMULATION METHOD BASED ON YIELD CRITERION CONSTRAINT

(71) Applicant: BEIHANG UNIVERSITY, Beijing (CN)

(72) Inventors: Yang GAO, Beijing (CN); Aimin HAO, Beijing (CN); Xueguang XIE, Beijing (CN); Shuai LI, Beijing (CN); Jin LI, Beijing (CN)

(21) Appl. No.: 18/375,786

(22) Filed: Oct. 2, 2023

Related U.S. Application Data
(63) Continuation of application No. PCT/CN2021/105589, filed on Jul. 9, 2021.

(30) Foreign Application Priority Data
Apr. 25, 2021 (CN) 202110446067.8

(51) Int. Cl. G06F 30/28; G06F 30/25

(52) U.S. Cl. CPC G06F 30/28; G06F 30/25; G06F 2111/04

(57) ABSTRACT

The embodiments of the present disclosure disclose a viscous fluid simulation method based on yield criterion constraints. The method comprises: initializing a viscous fluid simulation scenario; determining a particle velocity after a time step based on an implicit fluid particle model; determining a particle temperature after the time step by simulating a heat conduction process; correcting the particle velocity based on the particle temperature, thus achieving temperature dependent viscous fluid flow phenomena simulation based on yield criterion constraints, and expanding the range of simulation types.

### CROSS-REFERENCE TO RELATED APPLICATIONS

The present application is a bypass continuation application of PCT application number PCT/CN2021/105589. The present application claims priorities from PCT application number PCT/CN2021/105589, filed Jul. 9, 2021, and from Chinese application number 2021104460678, filed Apr. 25, 2021, the disclosure of which are hereby incorporated by reference herein in its entirety.

### TECHNICAL FIELD

The embodiments of the present disclosure relate to the field of computer technology, and in particular, to a viscous fluid simulation method based on yield criterion constraints.

### BACKGROUND

In recent years, more and more researchers in the field of fluid simulation based on computer graphics pay attention to the study of viscous fluid phenomena. Some methods of viscous fluid simulation have been proposed successively, including viscosity term numerical solution based on Smoothed Particle Hydrodynamics (SPH) method, introduction of Material Point Method (MPM), introduction of shape matching constraint conditions, etc. However, due to the more complex and variable motion process of viscous fluids compared to non-viscous fluids, the calculation of the motion process is cumbersome, so there is still a lot of research space in terms of computational efficiency and algorithm stability.

Common viscous fluid simulation researches are divided into two trains of thought: viscosity term numerical solutions based on hydrodynamic equations and viscous behavior constraints based on geometric modeling modifications. In the aspect of realizing fluid viscosity by numerical solutions, modifying the viscosity term of a SPH kernel function may enable the SPH to simulate the behavior of non-Newtonian viscous fluids such as foam, honey, etc.; based on the energy equation of Helmholtz free energy, controlling the conversion of fluid viscosity from high-energy to low-energy states may approximately simulate the interaction of many viscous fluids, such as the mixing of various pigments, the viscous fluid behavior of egg white and yolk, etc.; the MPM method uses a MAC mesh to solve the pressure projection of viscous fluids to achieve fluid phenomena that consider viscous attributes, and may also simulate the flow of many viscous fluids such as honey, toothpaste, cream, and so on. The simulation of viscous fluid behavior based on geometric modeling constraints still follows the numerical model of non-viscous fluids when solving a hydrodynamic equation, and turns to apply additional constraints to the fluid behavior before updating the fluid velocity and displacement, to implement the simulation of viscous fluids. For example, applying viscoelastic constraints to the position and velocity of fluid particles through shape matching constraint conditions may limit the motion range of particles and thereby approximately simulate the motion process of viscous fluids; using a spatially adaptive tetrahedral mesh may achieve variable viscosity coefficients and support the stacking phenomenon of high viscosity surfaces; the method of applying additional constraints between particles after the Newtonian hydrodynamic solving step by a spring-proton model is also a simple way to simulate viscous fluids. Whether it be a method based on numerical solutions or an existing method based on geometric constraints, they most probably all have the drawbacks of complex computational models and low simulation efficiency. At the same time, for some viscous fluids such as blood flow, honey, etc., their viscosity is closely related to their temperature attributes, while existing methods rarely consider the relationship between fluid viscosity and temperature.

The yield criterion is a judgment condition used to control whether a material undergoes plastic deformation under complex stress states. The use of a yield criterion for judging the mutual constraint behavior between flowing material particles in graphics is simple and feasible, and the computational process is clear and easy to implement. The viscous fluid represented by particles is a continuous medium material, and its kinematic behavior may be described by hydrodynamic expressions. Assuming that the viscous fluid is a plastic flow and follows the plastic law, its viscosity attribute character may be described by the yield criterion as a constraint condition.

### SUMMARY

The content of the present disclosure is to briefly introduce the concepts, which will be described in detail in the mode of carrying out the disclosure later. The content of the present disclosure is not intended to identify key or necessary features of the claimed technical solution, nor is it intended to limit the scope of the claimed technical solution.

Some embodiments of the present disclosure propose a viscous fluid phenomena simulation method based on yield criterion constraints to solve one or more of the technical problems mentioned in the background of the disclosure above.

In the first aspect, some embodiments of the present disclosure provide a viscous fluid phenomena simulation method based on yield criterion constraints, the method comprising: initializing a viscous fluid simulation scenario, wherein the viscous fluid simulation scenario includes: viscous fluid motion regions, boundaries and initial conditions, the boundaries including semi-open boundaries and closed boundaries, the initial conditions including fluid position, density, temperature and velocity; determining a particle velocity after a time step based on an implicit fluid particle model; determining a particle temperature after the time step by simulating a heat conduction process; and correcting the particle velocity based on the particle temperature.

The above embodiments of the present disclosure have the following beneficial effects: Firstly, initializing a viscous fluid simulation scenario. Then, determining a particle velocity after a time step based on an implicit fluid particle model. Next, determining a particle temperature after the time step by simulating a heat conduction process. Lastly, correcting the particle velocity based on the particle temperature. Thus modeling the correlation between the fluid temperature and the fluid viscosity is achieved. At the same time, the complexity and the amount of calculation are less compared to existing viscous fluid simulation models, thereby meeting the viscous fluid phenomena simulation requirements based on physics.

The principle of the present disclosure lies in:

The present disclosure proposes a viscous fluid phenomena simulation method based on yield criterion constraints. The principle is that: compared to non-viscous fluids, viscous fluids based on particle representations demonstrate a greater viscous force between particles during motion. This viscous force is essentially a mutual constraint relationship between fluid particles, making viscous fluids exhibit a feature of slow flow and significant condensation phenomenon as a whole. The viscous behavior constraint method based on geometric model modification using a numerical calculation model of non-viscous fluids may have relatively high computational efficiency when solving the hydrodynamic behavior. Before updating the particle position and velocity, the geometric constraint method modifies the relative displacement, stress, velocity and other attributes characterizing viscosity between particles, thereby modeling the behavior of viscous fluids. The plastic yield criterion is a judgment condition used to control whether a material undergoes plastic deformation under complex stress states. The viscous fluid represented by particles is a continuous medium material, and its kinematic behavior may be described by hydrodynamic expressions. Assuming that the viscous fluid is a plastic flow and follows the Mohr-Coulomb plastic law, its viscous behavior may be described through the plastic yield criterion.

At the same time, the viscosity attributes of viscous fluids are highly correlated with their temperature. The higher the temperature of a viscous fluid, the more active the molecular motion it constitutes, and at the macro level, the viscosity attribute character of the fluid is less obvious. On the contrary, the lower the temperature of the viscous fluid, the less active the molecular motion it constitutes, and at the macro level, the viscosity attribute character of the fluid is distinct, that is, the lower the fluid temperature, the greater the viscosity. Considering the correspondence relationship between the temperature and viscosity attributes, introducing temperature attributes and related coefficients controlling temperature weights into the yield criterion constraint may achieve a temperature sensitive yield criterion constraint model, thereby simulating viscous fluid phenomena with different viscosities under different temperature conditions.

The advantages of the present disclosure compared to the prior art are:

1. The viscous fluid phenomena simulation method based on yield criterion constraints proposed by the present disclosure is applied to the field of computer animation and virtual reality scene modeling. It innovatively introduces yield criterion constraints into particle based viscous fluid modeling to simulate fluid viscosity. Compared with existing viscous fluid simulation methods, it is more simple and easy to implement.

2. The present disclosure improves the yield criterion constraint conditions, by introducing temperature characteristics and weight parameters, achieves the correlation between the viscous fluid temperature attributes and viscosity attributes, being able to model the fluid phenomena with different viscosities at different temperatures.

3. The viscous fluid phenomenon based on yield criterion constraints proposed in the present disclosure has the advantages of strong scalability and wide simulation types. Temperature sensitive viscous fluids such as blood flow, honey, cream, toothpaste, etc. may all be simulated through the method proposed in the present disclosure.

### BRIEF DESCRIPTION OF THE DRAWINGS

The above and other features, advantages, and aspects of the embodiments of the present disclosure will become more apparent in conjunction with the accompanying drawings and with reference to the following specific implementations. Throughout the drawings, the same or similar reference signs indicate the same or similar elements. It should be understood that the drawings are schematic, and the components and elements are not necessarily drawn to scale.

FIG. 1 is a flowchart of the viscous fluid simulation method based on yield criterion constraints according to some embodiments of the present disclosure;

FIG. 2 is a flowchart of some embodiments of the viscous fluid simulation method based on yield criterion constraints according to the present disclosure;

FIG. 3 is a schematic diagram of the temperature mapping process of the viscous fluid simulation method based on yield criterion constraints of the present disclosure;

FIG. 4 is a schematic diagram of the heat conduction of viscous fluid particles of the viscous fluid simulation method based on yield criterion constraints of the present disclosure;

FIG. 5 shows the effect of viscous fluid behavior at 20 degrees Celsius;

FIG. 6 shows the effect of viscous fluid behavior at 80 degrees Celsius

### DETAILED DESCRIPTION OF THE DISCLOSURE

Hereinafter, the embodiments of the present disclosure will be described in more detail with reference to the accompanying drawings. Although certain embodiments of the present disclosure are shown in the drawings, it should be understood that the present disclosure may be implemented in various forms, and shall not be construed as being limited to the embodiments set forth herein. On the contrary, these embodiments are provided for a more thorough and complete understanding of the present disclosure. It should be understood that the drawings and embodiments of the present disclosure are used only for illustrative purposes, not to limit the protection scope of the present disclosure.

Besides, it should be noted that, for ease of description, only the portions related to the relevant disclosure are shown in the drawings. In the case of no conflict, the embodiments in the present disclosure and the features in the embodiments may be combined with each other.

It should be noted that concepts such as “first” and “second” mentioned in the present disclosure are only used to distinguish different devices, modules or units, and are not used to limit the order of functions performed by these devices, modules or units or interdependence thereof.

It should be noted that such adjuncts as “one” and “more” mentioned in the present disclosure are illustrative, not restrictive, and those skilled in the art should understand that, unless the context clearly indicates otherwise, they should be understood as “one or more”.

The names of messages or information interacting between multiple devices in the embodiments of the present disclosure are only for illustrative purposes, and are not intended to limit the scope of these messages or information.

The present disclosure will be described in detail below with reference to the accompanying drawings and in conjunction with embodiments.

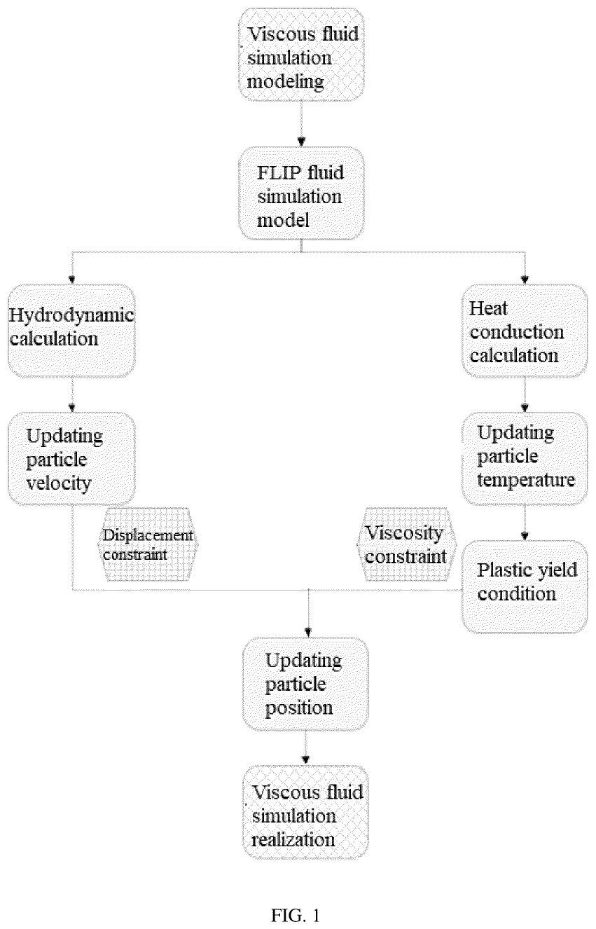

FIG. 1 is a flowchart of the viscous fluid simulation method based on yield criterion constraints according to some embodiments of the present disclosure. FIG. 1 shows the overall processing flow of the viscous fluid phenomena simulation method based on yield criterion constraints. The present disclosure is further explained in conjunction with other accompanying drawings and specific implementation methods.

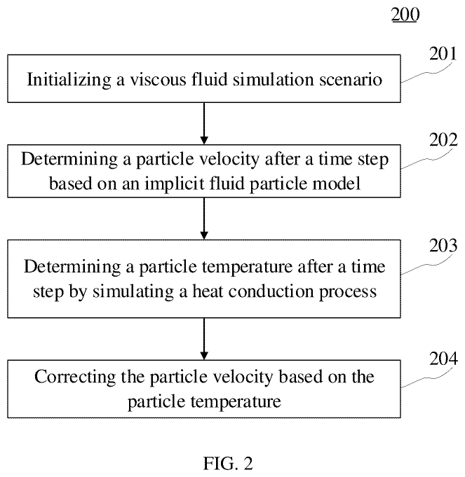

Continuing to see FIG. 2, which shows a flowchart 200 of some embodiments of the viscous fluid simulation method based on yield criterion constraints according to the present disclosure. The viscous fluid simulation method based on yield criterion constraints comprises the following steps:

Step 201, initialize a viscous fluid simulation scenario.

In some embodiments, the executing body of the viscous fluid simulation method based on yield criterion constraints may initialize a viscous fluid simulation scenario by receiving the preset initial parameters. Wherein, the viscous fluid simulation scenario may be used for fluid simulation of viscous fluids. The viscous fluid simulation scenario may include: viscous fluid motion regions, boundaries and initial conditions, the boundaries may include semi-open boundaries and closed boundaries, the initial conditions may include fluid position, density, temperature and velocity. The viscous fluid motion regions may be the spatial range of viscous fluid activities. The viscous fluids mentioned above may include at least one fluid particle. The semi-open boundaries may be the boundaries of an open area. The closed boundaries be the boundaries of a closed area. The fluid position may be the position of the fluid particle in the viscous fluid simulation scenario.

As an example, the viscous fluids mentioned above may be blood. The viscous fluid motion region may be the spatial range within a cup.

Step 202, determine a particle velocity after a time step based on an implicit fluid particle model.

In some embodiments, the above executing body may determine a particle velocity after the time step based on the implicit fluid particle model. Wherein, the implicit fluid particle model may be a FLIP (Fluid Implicit Particles) model. The particle velocity above may be the velocity of fluid particles.

Optionally, the above executing body determining a particle velocity after a time step based on an implicit fluid particle model may include the following steps:

The first step is to interpolate the velocity included in the initial conditions in the viscous fluid simulation scenario onto a 3D network. Wherein, the 3D network may include at least one 3D mesh. The 3D mesh in the 3D network corresponds to the fluid position of the fluid particles in the viscous fluid simulation scenario. The 3D network may be a 3D space. The 3D mesh may be the shape of a 3D object composed of meshes. The size of each 3D mesh in the 3D network is equal. The above executing body may project the velocity of the fluid particles in the simulation scenario to the corresponding positions in the 3D network.

The second step is to determine the velocity of the fluid particles on the 3D mesh after the time step by solving the following equation:

$$\frac{\partial ρ}{\partial t} + ρ ∇ \cdot u = 0 , \\ ρ ( \frac{\partial u}{\partial t} + u \cdot ∇ u ) = - ∇ p + μ {∇}^{2} u + f .$$

Wherein, t represents time, p represents the density of the fluid at time t, u represents the velocity of the fluid particles at time t, p represents the preset pressure of the fluid at time t, and f represents the external force acting on the fluid particles at time t.

The third step is to determine the difference between the velocity of the fluid particles on the 3D mesh and the velocity included in the initial conditions in the viscous fluid simulation scenario, as the velocity change.

Furthermore, based on the interpolation method of the implicit fluid particle model mentioned above, the velocity change is interpolated back into the fluid particles.

The fourth step is to determine the particle velocity using the following formula:

v=αv_{FLIP}+(1−α)v_{PIC}.

Wherein, v represents the particle velocity, α represents the first weight, and the value range of α is [0,1], v_{FLIP} represents the velocity obtained from the implicit fluid particle model, and v_{PIC} represents the velocity obtained using the PIC (particle in cell) method.

Wherein, the first weight represents the proportion of velocity obtained from the implicit fluid particle model.

Step 203, determine a particle temperature after the time step by simulating a heat conduction process.

In some embodiments, the above executing body may determine a particle temperature after the time step by simulating a heat conduction process. Wherein, the heat conduction process may be a heat transfer process.

Optionally, the executing body determining a particle temperature after the time step by simulating a heat conduction process may include the following steps:

The first step is to interpolate the temperature included in the initial conditions in the viscous fluid simulation scenario, onto the 3D mesh.

The second step is to simulate the heat conduction process by solving the following equation to determine the temperature of the particles after the time step in the 3D mesh in the 3D network:

$$\frac{T}{Δ t} = b ( \frac{{\partial }^{2} T}{\partial {x}^{2}} + \frac{{\partial }^{2} T}{\partial {y}^{2}} + \frac{{\partial }^{2} T}{\partial {z}^{2}} ) .$$

Wherein, T represents temperature, b represents the thermal diffusion coefficient of the heat conduction model, t represents time, Δt represents the time step, x represents the abscissa of the coordinates of the mesh points in the 3D mesh, y represents the ordinate of the coordinates of the mesh points in the 3D mesh, and z represents the third dimensional coordinate of the coordinates of the mesh points in the 3D mesh.

The third step is to determine the difference between the temperature of the fluid particles after the time step in the 3D mesh in the 3D network and the temperature included in the initial conditions in the viscous fluid simulation scenario, as the temperature change.

The fourth step is to interpolate the temperature change back to the particles based on the implicit fluid particle model.

The fifth step is to determine the particle temperature of the fluid particles using the following formula:

TN=αF+(1−α)P.

Wherein, TN represents the particle temperature, α represents the first weight, and the value range of α is [0,1], F represents the temperature obtained using the FLIP model method, and P represents the temperature obtained using the PIC method.

Step 204, correct the particle velocity based on the particle temperature.

In some embodiments, the above executing body may use the particle temperature as an input parameter, calculate the frictional stress on the fluid particles based on the yield criterion constraint control equation, thereby approximately simulate the viscosity attributes between fluid particles through the increment of stress applied to the tangential velocity, to correct the particle velocity mentioned above.

Optionally, the executing body correcting the particle velocity based on the particle temperature may include the following steps:

The first step is to determine a first feature using the following formula, where the first feature may be the strain rate tensor of each 3D mesh in the 3D network:

$$D = \frac{∇ u + ∇ {u}^{T ′}}{2} .$$

Wherein, D represents the first feature, u represents the velocity of the fluid particle at time t, ∇u represents a gradient, and ∇u^{†} represents the transposition of the gradient ∇u.

The second step is to determine the frictional stress by the following formula based on the first feature:

$${σ}_{f} = - p \frac{D}{\sqrt{1 / 3} {\vert D \vert}_{F}} .$$

Wherein, σ_{f} represents the frictional stress, p represents the pressure, D represents the first feature, |D|_{F} represents the Frobenius norm of the first feature D.

The third step is, responsive to the position of the fluid particles being within the scenario, to correct the particle velocity of the fluid particles based on the aforementioned frictional stress and particle temperature, by the following formula:

$$u += β T \cdot \frac{Δ t}{ρ} ∇ \cdot {σ}_{f} .$$

Wherein, u represents the particle velocity of the fluid particles, σ_{f} represents the frictional stress, ∇·σ_{f} is the divergence of sliding friction force σ_{f} calculated by the central difference method, and β represents the preset weight coefficient.

The fourth step is, responsive to the position of the fluid particles being at the scenario boundary, to correct the tangential velocity of the fluid particles based on the particle velocity of the fluid particles, by the following formula:

$$UT = max ( 0 , 1 - \frac{μ \vert u \cdot n \vert}{\vert UT \vert} ) UT .$$

Wherein, UT represents the tangential velocity, μ represents the coefficient of friction, n represents the normal, and |u·n| represents the modulus of normal velocity.

In practice, the viscous fluid phenomena simulation method based on yield criterion constraints proposed by the disclosure is specifically implemented as hydrodynamic simulation based on FLIP models and viscous behavior correction based on yield criterion constraints. The main steps are as follows:

1. Modeling of Hydrodynamic Simulation

In order to calculate the attributes and motion process of fluid particles, a particle based method is used to solve the discrete N-S equation, which includes two important equation forms such as the above formula. Wherein, the first formula

$$\frac{\partial ρ}{\partial t} + ρ ∇ \cdot u = 0$$

is called a continuity equation, which mainly functions to maintain the conservation of mass of the fluid; the second formula

$$ρ ( \frac{\partial u}{\partial t} + u \cdot ∇ u ) = - ∇ p + μ {∇}^{2} u + f$$

is called the momentum equation of a fluid, which represents the variation of fluid velocity over time under the combined action of pressure, viscous force, and external force. The FLIP model, as a particle-mesh hybrid model, also realizes the simulation of hydrodynamic behavior by solving N-S equations in nature. Unlike the Eulerian mesh method that directly solves N-S equations, the fluid behavior in the FLIP method is based on a discrete particle model, where the attributes of the fluid particles are first projected onto the mesh for solution, i.e., FLIP solves N-S equations through the mesh, then interpolates the variation in velocity back into the fluid particles from the mesh, thereby driving the motion of the fluid particles. The FLIP method was developed from the PIC method, with the difference being that the PIC method directly interpolates the obtained velocity values back into the fluid particles. In contrast, the FLIP method only transmits the variation in velocity, thus avoiding the accumulation of errors and having higher accuracy than the PIC method. Usually, using the velocity weighted average of PIC and FLIP as the new velocity of fluid particles may ensure the stability of fluid simulation, and minimize the accumulation of interpolation errors as much as possible.

2. Simulation of Heat Conduction Process

The viscous fluid phenomena simulation based on heat conduction models may demonstrate the influence of different temperature conditions on fluid viscosity. Thanks to the fact that the calculation of particle attributes in the FLIP model is entirely based on mesh solving, it is very suitable for combining with simplified heat conduction models based on mesh solving.

In order to simulate the heat conduction process, an additional temperature attribute needs to be added to all particles, and a temperature value is given during the scenario initialization. The temperature change is based on the calculation results of the heat conduction model. Within each time step, the temperature of the mesh points is interpolated by particles.

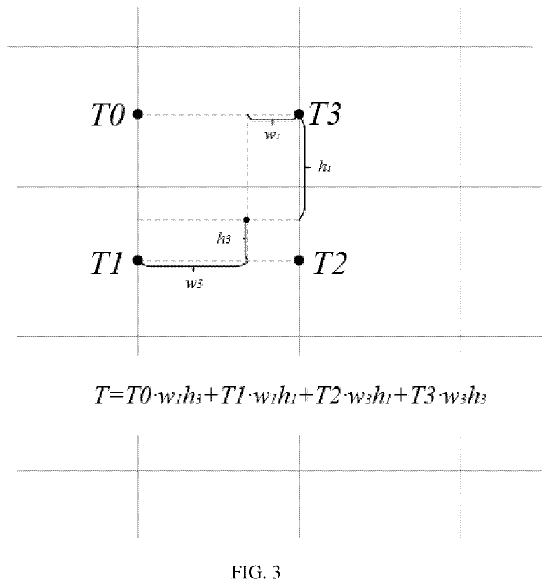

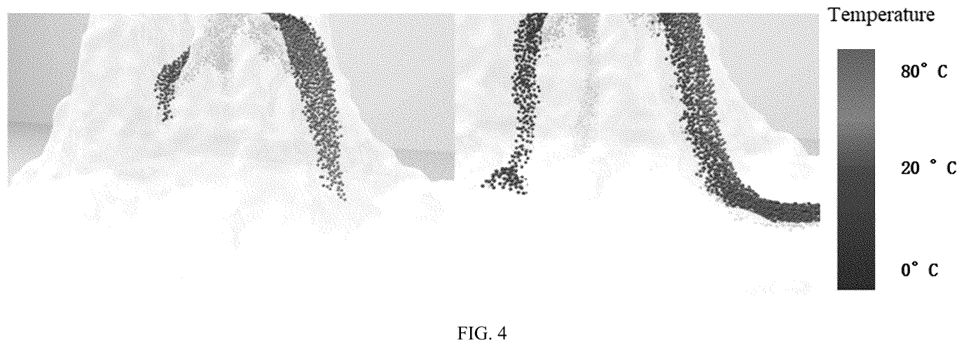

After updating the temperature values at the mesh points, map the change of temperature back to the particles (the mapping process is shown in FIG. 3). Then, update the current temperature of the particles. For the temperature update rules, see the mode of combining the FLIP model method with the PIC method. The heat conduction process between different particles is shown in FIG. 4, which illustrates the heat conduction process of fluid particles. The high-temperature fluid impacts a solid model, causing the temperature of the fluid particles to gradually decrease due to the lower temperature of the solid model. At the same time, the fluid particles also conduct heat during mutual collisions. In order to clearly demonstrate the heat conduction process, the particle model in the figure is colored according to the temperature level. Color information represents different temperatures of particles, with light particles representing high-temperature particles and dark particles representing low-temperature particles.

3. Simulation of Viscosity Attribute

In order to simulate the sand state of powder materials, the present disclosure adds a step of controlling particle friction and plasticity to simulate viscous properties after the pressure projection step of a FLIP fluid solver.

Firstly, use the standard central differences method to estimate the 3×3 strain rate tensor D of each cell in the mesh.

Usually, the frictional stress during fluid particle flow is calculated using the following formula:

$${σ}_{f} = - sin φ p \frac{D}{\sqrt{1 / 3} {\vert D \vert}_{F}} .$$

Wherein, σ_{f} represents the frictional stress, φ represents the friction angle, representing the maximum slope of the particle material when it is stationary and stacked, the smaller the φ, the flatter the stacked state; p represents the pressure, which is the pressure calculated in the pressure projection step, and its gradient represents the effect on velocity; D represents the strain rate tensor; |D|_{F} represents the Frobenius norm of the strain rate tensor D.

For viscous fluids, only the flow motion of the viscous fluid needs to be considered, which means that fluid particles cannot form a static stacking effect, and the tangential stress weight between particles is the highest, so the friction angle φ takes 90°.

Next, for all viscous fluid cells, the velocity is updated based on the obtained temperature TN. The preset weight coefficients mentioned above are variable coefficients that may control the temperature weight. The larger the preset weight coefficients, the greater the influence of temperature on particle viscosity. The higher the temperature, the greater the viscosity between fluid particles.

After processing the internal velocity of a viscous fluid, it is also necessary to replace the boundary conditions with frictional boundary conditions, to apply friction between viscous fluid particles and external objects such as walls and obstacles. The present disclosure applies friction treatment only to the boundary cells where the normal velocity points towards the interior of the object (i.e., the interior of the viscous fluid), and corrects their tangential velocity.

After completing the above steps, enter the next simulation time step and repeat the above steps, thereby achieving temperature dependent viscous fluid flow phenomena simulation based on yield criterion constraints.

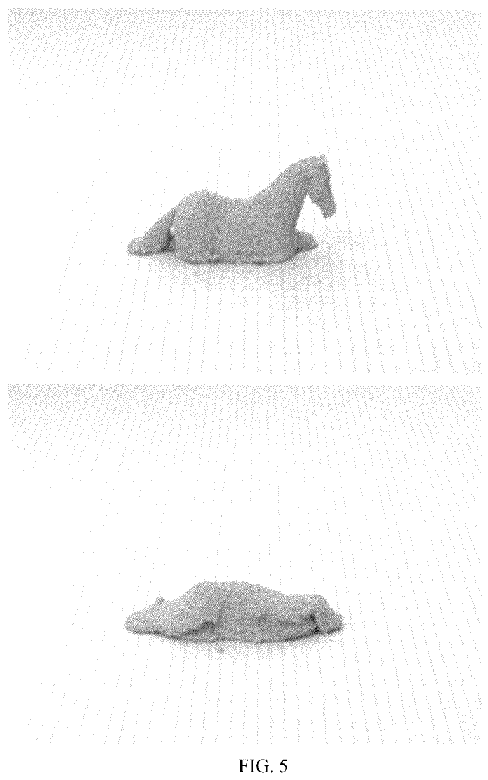

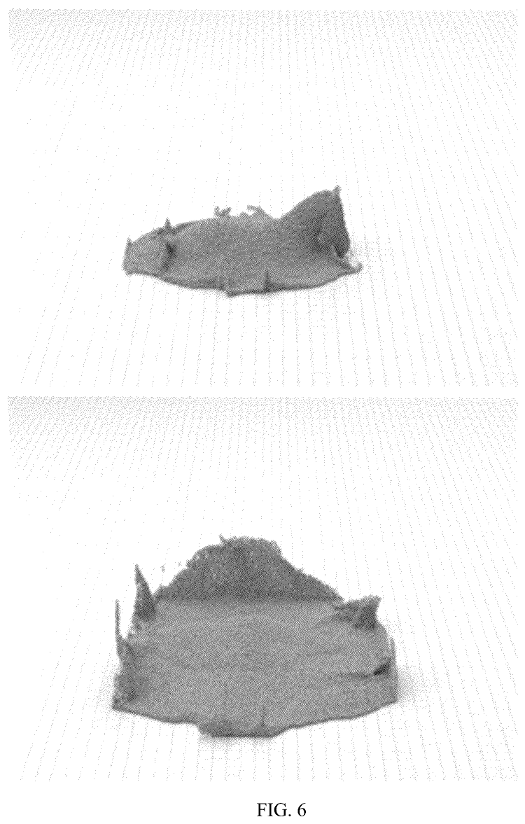

In order to prove the correctness and effectiveness of the present disclosure in the field of computer animation, a 3D flow field scenario with closed boundaries is designed, and the viscous fluid model fell in free fall onto the floor of the scenario under the action of gravity. As a comparison, both FIG. 5 and FIG. 6 adopt the fluid simulation method based on yield criterion constraints proposed by the present disclosure. The initial temperature of the fluid particles in FIG. 5 is 20° C., while in FIG. 6, the initial temperature of the fluid particles is 80° C. From these two figures, it can be clearly seen that the method of the present disclosure may effectively simulate the viscous fluid phenomenon. At the same time, there are significant differences in the viscosity performance of fluids at different temperatures, indicating that the present disclosure may visually simulate the behavior of viscous fluids based on yield criterion constraints, and may simulate the viscosity performance of different fluids at different temperatures.

The technical content not detailed in the present disclosure belongs to the well-known technology of those skilled in the art.

Although the specific embodiments of the present disclosure have been described above to facilitate the understanding of those skilled in the art, it should be clear that the present disclosure is not limited to the scope of these specific embodiments. For ordinary technical personnel in the art, as long as variations are within the spirit and scope of the present disclosure as defined and determined by the attached claims, these variations are obvious, and all disclosures and creations that utilize the concept of the present disclosure are under protection.

1. A viscous fluid simulation method based on yield criterion constraints, comprising:
initializing a viscous fluid simulation scenario, wherein the viscous fluid simulation scenario includes: viscous fluid motion regions, boundaries and initial conditions, the boundaries including semi-open boundaries and closed boundaries, and the initial conditions including fluid position, density, temperature and velocity;
determining a particle velocity after a time step based on an implicit fluid particle model;
determining a particle temperature after the time step by simulating a heat conduction process; and
correcting the particle velocity based on the particle temperature.

2. The method of claim 1, wherein, the determining a particle velocity after a time step based on an implicit fluid particle model includes:
interpolating the velocity included in the initial conditions in the viscous fluid simulation scenario, onto a 3D network, wherein, the 3D network includes at least one 3D mesh, the 3D mesh in the 3D network corresponds to the fluid position of fluid particles in the viscous fluid simulation scenario;
determining the velocity of the fluid particles on the 3D network after the time step by solving the following equation:
$$\frac{\partial ρ}{\partial t} + ρ ∇ \cdot u = 0 , \\ ρ ( \frac{\partial u}{\partial t} + u \cdot ∇ u ) = - ∇ p + μ {∇}^{2} u + f ,$$
wherein, t represents time, ρ represents the density of the fluid at time t, u represents the velocity of the fluid particles at time t, p represents a preset pressure of the fluid at time t, and f represents an external force acting on the fluid particles at time t;
determining a difference between the velocity of the fluid particles on the 3D network and the velocity included in the initial conditions in the viscous fluid simulation scenario, as a velocity change;
based on an interpolation method of the implicit fluid particle model, interpolating the velocity change back into the fluid particles;
determining the particle velocity using the following formula:
v=αv_{FLIP}+(1−α)v_{PIC},
wherein, v represents the particle velocity, α represents a first weight, and a value range of α is [0,1], v_{FLIP} represents a velocity obtained from the implicit fluid particle model, v_{PIC} represents a velocity obtained using a PIC (particle in cell) method.

3. The method of claim 2, wherein, the determining a particle temperature after a time step by simulating a heat conduction process includes:
interpolating the temperature included in the initial conditions in the viscous fluid simulation scenario onto the 3D mesh;
simulating the heat conduction process by solving the following equation to determine the temperature of the fluid particles after the time step in the 3D mesh in the 3D network:
$$\frac{T}{Δ t} = b ( \frac{{\partial }^{2} T}{\partial {x}^{2}} + \frac{{\partial }^{2} T}{\partial {y}^{2}} + \frac{{\partial }^{2} T}{\partial {z}^{2}} ) ,$$
wherein, T represents the temperature, b represents a thermal diffusion coefficient of the heat conduction model, t represents time, Δt represents the time step, x represents abscissa of coordinates of mesh points in the 3D mesh, y represents ordinate of the coordinates of the mesh points in the 3D mesh, and z represents a third dimensional coordinate of the coordinates of the mesh points in the 3D mesh;
determining a difference between the temperature of the fluid particles after the time step in the 3D mesh in the 3D network and the temperature included in the initial conditions in the viscous fluid simulation scenario, as a temperature change.

4. The method of claim 3, wherein, the determining a particle temperature after a time step by simulating a heat conduction process further includes:
interpolating the temperature change back to the particles based on the implicit fluid particle model;
determining the particle temperature of the fluid particles using the following formula:
TN=αF+(1−α)P,
wherein, TN represents the particle temperature, α represents a first weight, and a value range of α is [0,1], F represents a temperature obtained using the FLIP method, and P represents a temperature obtained using the PIC method.

5. The method of claim 4, wherein, the correcting the particle velocity based on the particle temperature includes:
determining a first feature using the following formula:
$$D = \frac{∇ u + ∇ {u}^{T ′}}{2} ,$$
wherein, D represents the first feature, u represents the velocity of the fluid particle at time t, ∇u represents a gradient, and ∇u^{†} represents a transposition of the gradient ∇u;
determining a frictional stress by the following formula based on the first feature:
$${σ}_{f} = - p \frac{D}{\sqrt{1 / 3} {\vert D \vert}_{F}} ,$$
wherein, σ_{f} represents the frictional stress, p represents a pressure, D represents the first feature, |D|_{F} represents a Frobenius norm of the first feature D;
responsive to the position of the fluid particles being within the scenario, correcting the particle velocity of the fluid particles based on the frictional stress and particle temperature, by the following formula:
$$u += β T \cdot \frac{Δ t}{ρ} ∇ \cdot {σ}_{f} ,$$
wherein, u represents the particle velocity of the fluid particles, σ_{f} represents the frictional stress, ∇·σ_{f} is a divergence of sliding friction force σ_{f} calculated by a central difference method, β represents a preset weight coefficient;
responsive to the position of the fluid particles being at the scenario boundary, correcting a tangential velocity of the fluid particles based on the particle velocity of the fluid particles, by the following formula:
$$UT = max ( 0 , 1 - \frac{μ \vert u \cdot n \vert}{\vert UT \vert} ) UT ,$$
wherein, UT represents the tangential velocity, μ represents a coefficient of friction, n represents a normal, and |u·n| represents a modulus of normal velocity.
